(19) United States
(12) Patent Application Publication
(10) Pub. No.: US 2011/0242108 A1
(43) Pub. Date: Oct. 6, 2011

(54) VISUALIZATION OF COMPLEXLY RELATED DATA

(75) Inventors: Vijay Mital, Kirkland, MA (US); Darryl Ellis Rubin, Redmond, WA (US); David G. Green, Redmond, WA (US); John A. Payne, Seattle, WA (US); Suraj T. Poozhiyil, Redmond, WA (US)

(73) Assignee: Microsoft Corporation, Redmond, WA (US)

(21) Appl. No.: 12/751,866

(22) Filed: Mar. 31, 2010

(51) Int. Cl. G06T 11/20

(52) U.S. Cl. 345/440.2; 345/440

(57) ABSTRACT

A method for displaying complex relationships among data that includes selecting a first subset, a second subject, and a third subset of data from a database. Two or more relationships are identified among the first, second, and third subsets of data. One or more visualizations are provided that display the two or more relationships among the first, second, and third subsets of data.

### BACKGROUND

Spreadsheets are computer programs that display multiple cells, typically as a grid of rows and columns. The cells may accept and display data in the form of numeric values or text. Alternatively, cells may display results of functions that perform calculations using the contents of one or more other cells as input. Cells that contain functions typically update automatically when input from another cell is changed. Additionally, spreadsheets may allow graphs and charts or other visualizations to be created from data of the spreadsheet. MICROSOFT EXCEL (TRADEMARK) is one spreadsheet with these capabilities. Spreadsheets, however, are not capable of providing visualizations of complexly related data.

Databases, such as MICROSOFT ACCESS (TRADEMARK), house collections of data, much of which is classified according to a particular scheme or that is otherwise related to one another. Databases may be queried by a user when there is a desire to identify particular database content, or relationships among database content. Output from a database query, however, typically is reduced to a tabular report or other type of visualization that is incapable of illustrating multiple relationships within the data.

### SUMMARY

A method and/or a computer readable medium for providing visualizations that show multiple relationships within the data that is being visualized. Databases are often used to store and/or access data that is related in a complex manner, meaning that any datum or class of data may be related in multiple ways to other data. One example of such a database is MICROSOFT ACCESS (TRADEMARK). The visualizations, according to many embodiments, may be nested to allow a user to visualize the complex relationships. Various embodiments may additionally or alternatively include features normally associated with spreadsheets, such as MICROSOFT EXCEL (TRADEMARK), including but not limited to in situ calculations, sorting/filtering/aggregating functions, in situ transformations, and auto-naming among other features).

According to one aspect, a method is disclosed for displaying complex relationships among data. The method comprises selecting a first subset, a second subject, and a third subset of data from a database. Two or more relationships are identified among the first, second, and third subsets of data. One or more visualizations that display the two or more relationships among the first, second, and third subsets of data are then provided.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIGS. 1a-1c are views of partial screen shots that show a table of movies and corresponding data for each movie, icons representative of movies that have been chosen from a table, and a matrix-like visualization of various relationships associated with the movies chosen from the table and of different types of awards that each of the movies has been associated with.

FIG. 2 shows a table that includes icons which may be selected to expand nested visualizations.

FIG. 3 shows a visualization of FIG. 2, with one nested visualization in an expanded state.

FIG. 4 shows the expanded, nested visualization of FIG. 3 depicted in a different type of visualization.

FIG. 5 shows the visualization of FIG. 2, with an additional column added that provides a scalar quantity calculated from data associated with each row.

FIG. 6 shows an embodiment like that of FIG. 2 where a column has been added that includes a vector that has been calculated from data associated with each row of the table.

FIG. 7 shows a table that like of FIG. 5, including an additional column where entries identified as having similar calculated results are shown.

FIGS. 8a-8d show a plurality of partial screen shots depicting data that may be used to build a composite visual, like that shown in FIG. 1.

FIG. 9 shows a table, like that of FIG. 1, where a pop-up screen has been activated that provides editing functions for nested visualizations.

FIG. 10 shows a visualization like that of FIG. 1, where pop-ups have been activated to select the type of nested visualization that is used.

### DETAILED DESCRIPTION

An aspect of the invention relates to a method and to a computer readable medium for providing visualizations of complexly related data. Data may be housed in a database like structure. Each datum within the data may be related to multiple other data in various ways. Methods of the invention include identifying a first subset of data from the database, and then two or more additional types of data that are associated with each datum in the first subset. Relationships between data of the first subset, and subsets associated with each of the two or more additional types of data may then be identified. One or more visualizations are then provided that illustrate the relationships among the subsets of data.

According to some aspects of the invention, features normally associated with databases and spreadsheets are combined with the additional ability to provided visualizations of complexly related data. Databases typically allow for the storage and access of complexly related data. Spreadsheets allow for situ calculations of data, sorting/filtering/aggregation of data, and in situ transformations of data, among other functions. Any of these features or others normally associated with spreadsheets or databases may be combined with the ability to display visualizations of complexly related data.

Aspects of the invention may additionally relate to the analysis of complexly related data. According to some embodiments, data is identified that is similar to that of the first subset of data and that has similar relationships to associated data among other data. This analysis may include defining scalar values associated with the first subset of data that a user has chosen, and then identifying other relationships within the data that include similar values. This analysis may also include defining vector values, and then performing dot product or cross product analysis with other relationships among the data. Additionally or alternatively, constraints may be defined to focus the analysis to particular types of relationships among the data.

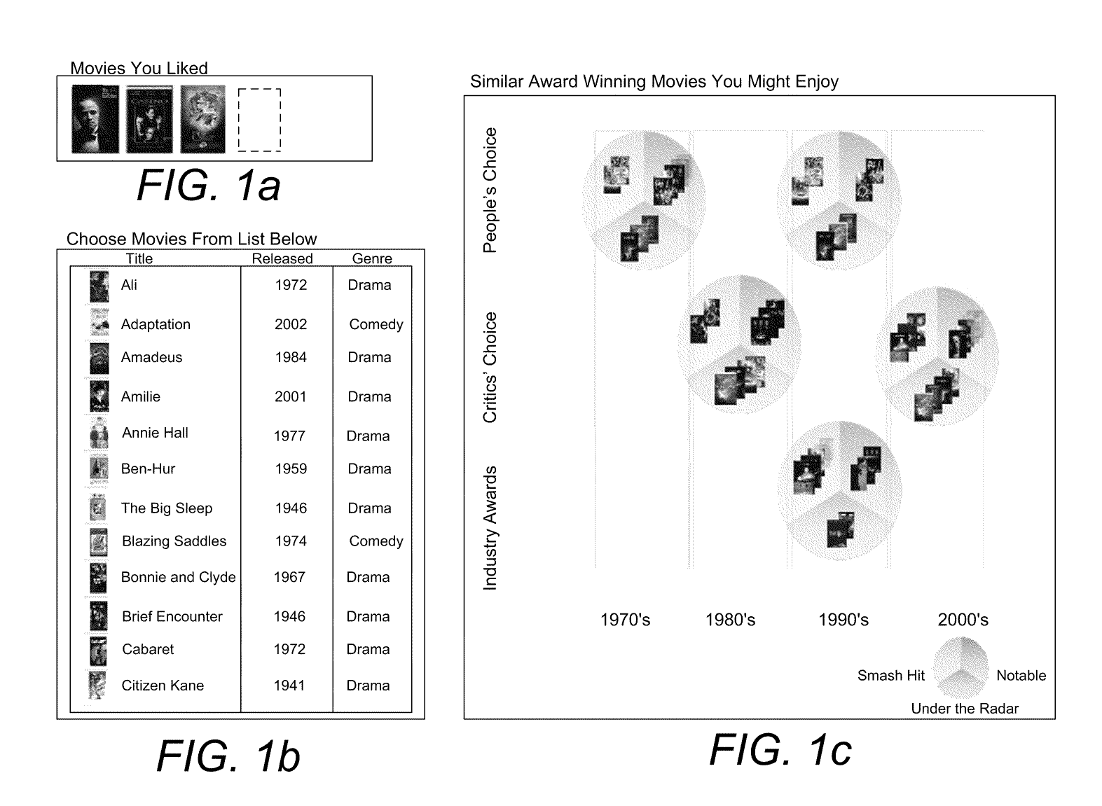

Turn now to the figures, and initially FIGS. 1a-1c, which are partial screen shots that show various aspects of a document canvas associated with the present inventions. FIG. 1a shows a table of movies and corresponding data for each movie. As shown, the table has a first column with an icon that represents the movie, a second column with the movie title, a third column with the release date of the movie, and a fourth column that includes a genre categorization for each movie. The table provides a visual of a subset of data that may be contained in the document canvas.

FIG. 1b is a workspace showing icons representative of movies that have been chosen from the table of FIG. 1a for analysis. In the embodiment represented, the user is asked to identify movies that they liked, so that the document canvas may identify other movies with similar characteristics that the user may wish to view. The workspace of FIG. 1b displays icons associated with each of the movies from FIG. 1a that the user has identified.

FIG. 1c shows a matrix-like visualization of various relationships associated is with the movies that were chosen from the table of FIG. 1a. The y-axis defines rows for different types of awards that the identified movies may have received. As shown, the types of awards include industry awards, critic's choice awards, and people's choice awards. The x-axis defines columns each associated with a particular decade, including the 1970's, the 1980's, the 1990's and the 2000's. Icons that represent the movies are displayed at the intersection of award type and decade with which the movies are associated.

The icons that represent movies in FIG. 1c are arranged within a circular pie chart at the intersections of corresponding rows and columns. Each circular pie chart is divided into thirds. Each third of the circular pie chart corresponds to yet another categorization for the movies, which in the illustrated embodiment represents the financial success of each movie. As may be gleaned from the key in the lower right hand corner of FIG. 1c, the upper left third of the pie chart corresponds to smash hits, the upper right hand corner corresponds to notable hits, and the lower third of the pie chart corresponds to under the radar type hits. In this respect, the embodiment of FIG. 1c includes multiple visuals, nested within one another, each showing a particular relationship among the data. It is to be appreciated that the embodiment of FIG. 1c is but one example of nested visuals, and that others are also contemplated.

It is to be appreciated that although various embodiments of the invention are described herein with respect to an application that involves cinema, that other applications and/or embodiments are also possible and are contemplated. The application relating to cinema is merely exemplary.

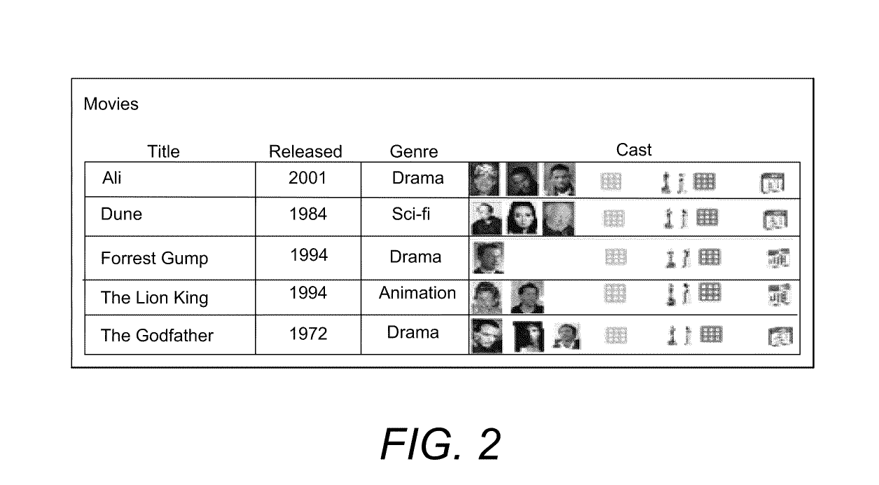

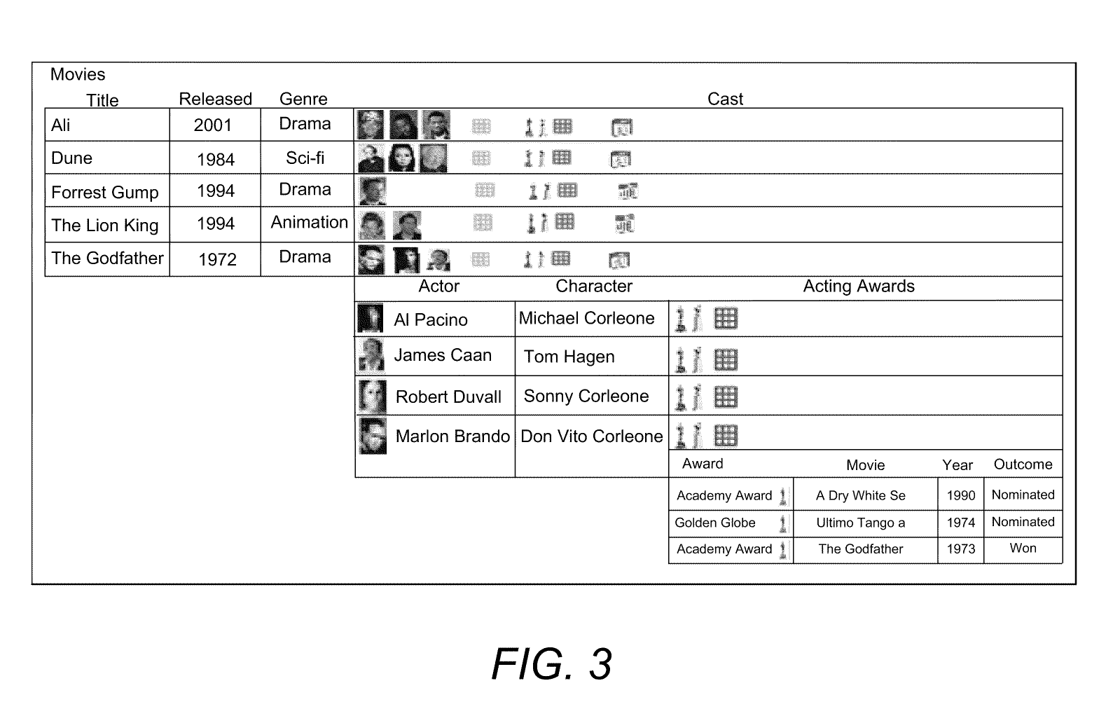

FIG. 2 shows a type of data visualization, according to another embodiment. The table of FIG. 2 includes columns for each of movie title, release date, genre, and cast members. Cast members are represented by icons that, as shown, depict an actual picture of the actor. To the right of each set of cast members for a given movie is an icon that appears as a table-like structure. When activated, the table-like structure icon causes a to nested visualization to expand from a minimized state to an expanded state, as shown and described with respect to FIG. 3.

A nested visualization that includes data associated with the movie “The Godfather” is shown in an expanded state in FIG. 3. In this embodiment, cast members for the movie are listed in each row of the expanded, nested visualization. Columns of the expanded visualization also include names of characters played by each cast member, and acting awards. The acting awards column also includes an icon that may be activated to expand yet another nested visual showing details as to which awards each actor has received, and the movie, year, and outcome for each award. The nested table for awards is also shown in an expanded state in FIG. 3.

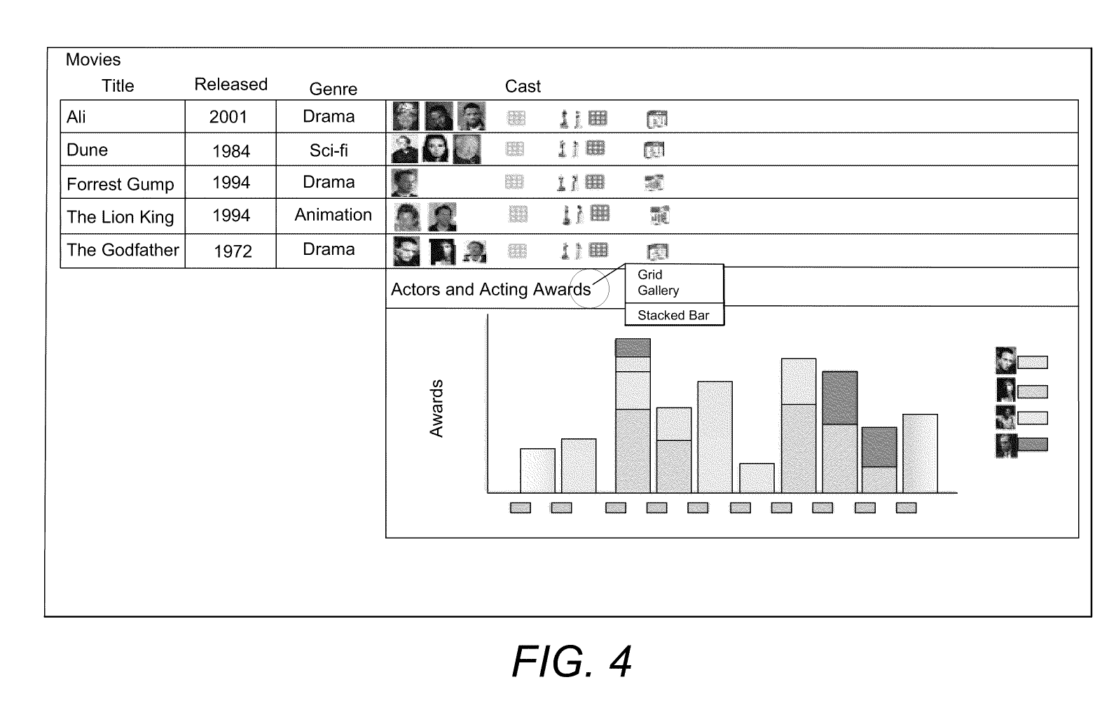

Different types of visualizations may be used to show the same data and/or relationships among data, even within the same application. By way of example, FIG. 4 shows bar graph visualization for actors and acting awards, rather than the table like visualization of FIG. 3. A user may toggle between different visualizations in different ways. In the illustrated embodiment, a user may activate a pull down menu that provides different visualization options, as shown in FIG. 4.

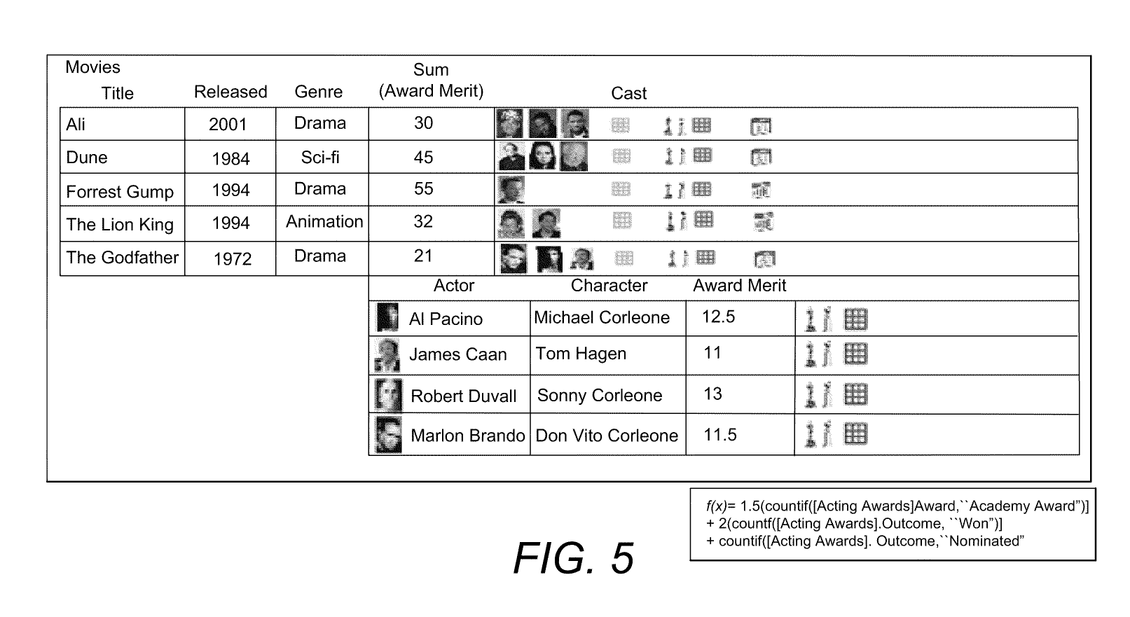

Various embodiments of the document canvas may also be capable of performing calculations on data. In the embodiment of FIG. 5, the nested table includes a column with a user defined function that operates on data in other portions of the document canvas. As illustrated, the function calculates an award merit sum that allots 3.5 points for every academy award that was won, and 2.5 points for every academy award nomination.

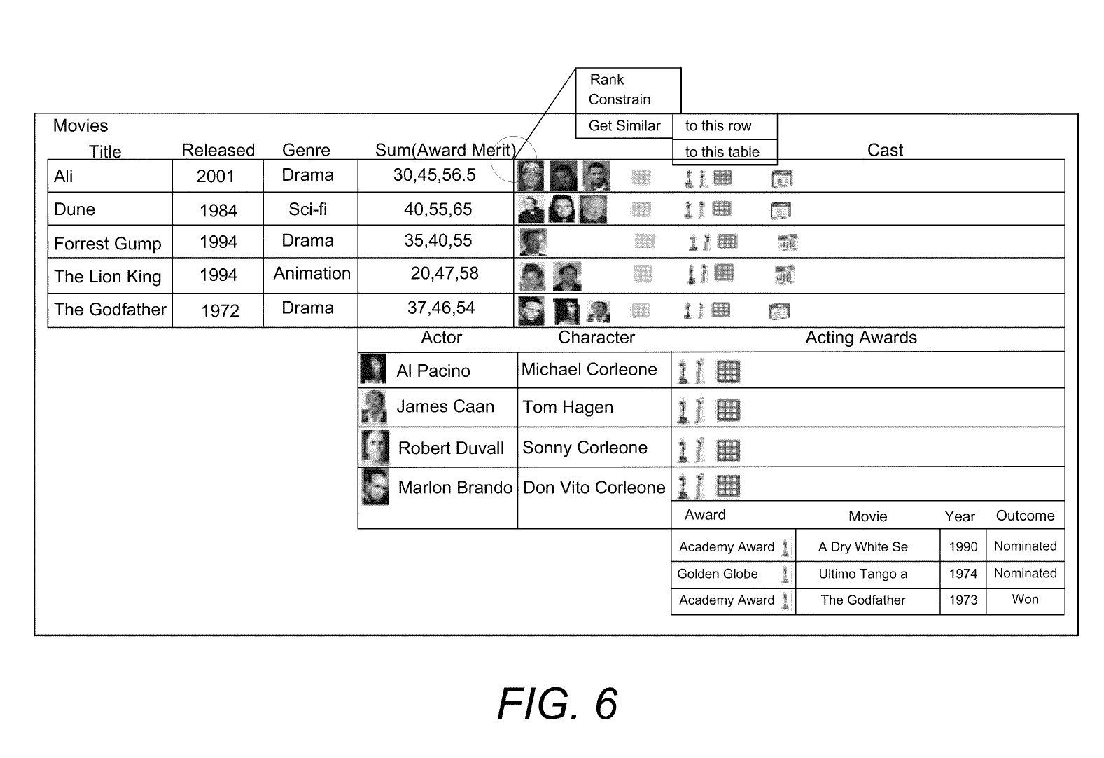

Functions are not limited to outputting scalar values. By way of example, FIG. 6 illustrates an embodiment like that of FIG. 5, but where the function outputs a vector of award sums. Each value of the vector is calculated in a manner similar to that described with respect to the embodiment of FIG. 5, but for different types of awards. For instance, the first value of the vector is calculated from data associated with academy awards, the second from golden globe awards, and so on. The resulting vector is displayed in a column of the table titled “Sum (Award Merit).”

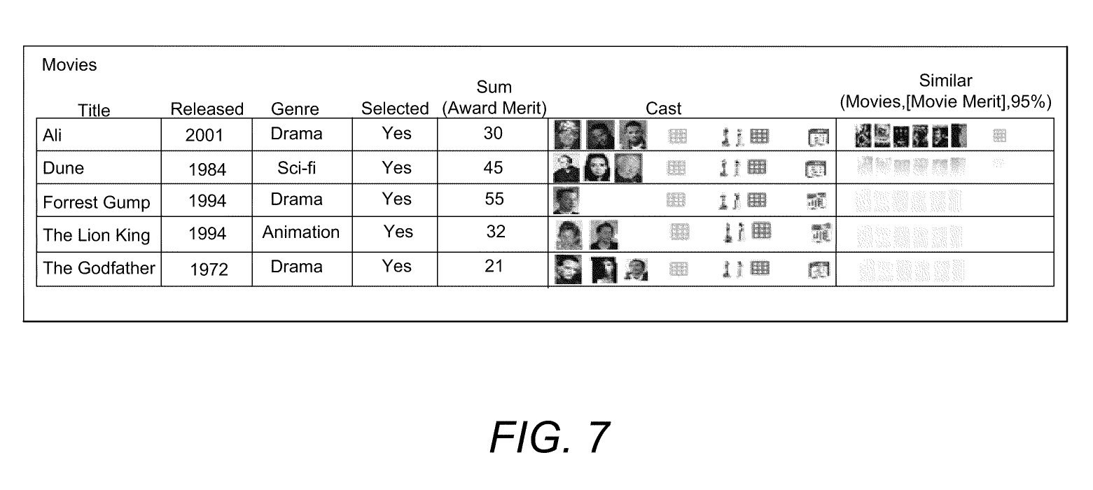

Calculations may, additionally, be performed on function results. One example of such a calculation is shown in FIG. 7, where the results of a query into movies with similar award merit sums is displayed. According to one embodiment, this calculation is performed by identifying movies with similar award merit sums from among the data. According to other embodiments, calculations may be performed on vectors, such as the vector shown in the embodiment of FIG. 6. Some examples of vector calculations include dot products and cross products, although others are also contemplated.

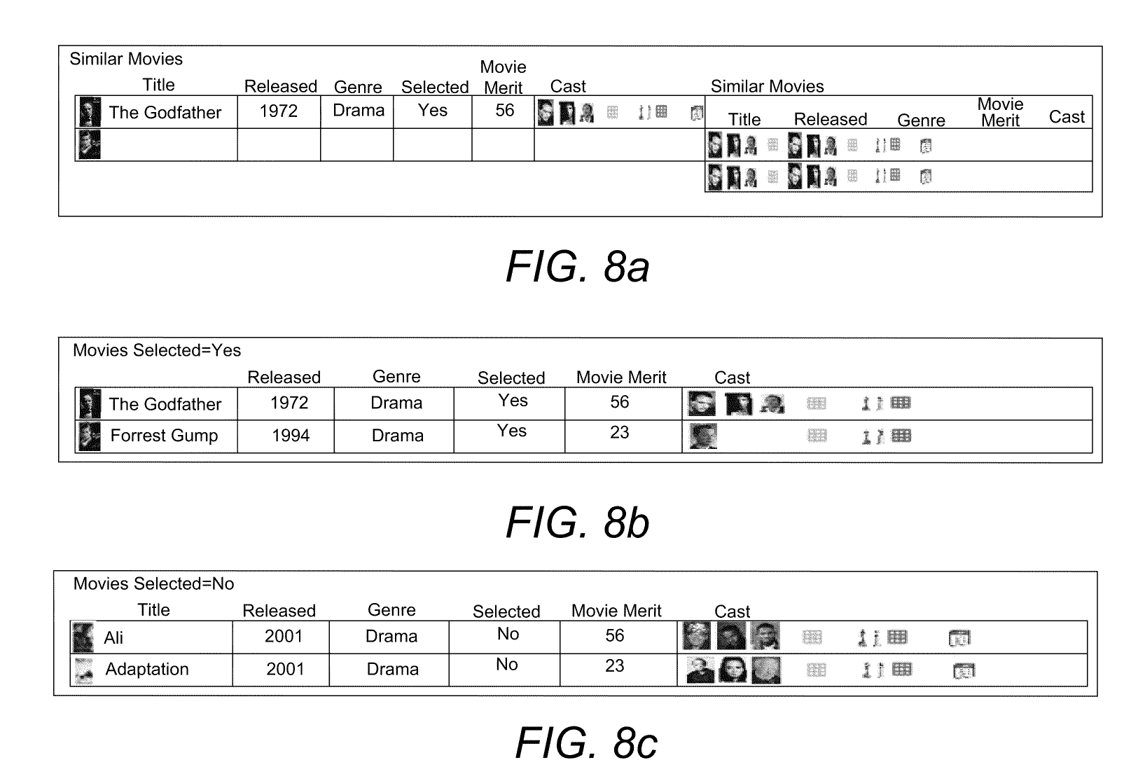

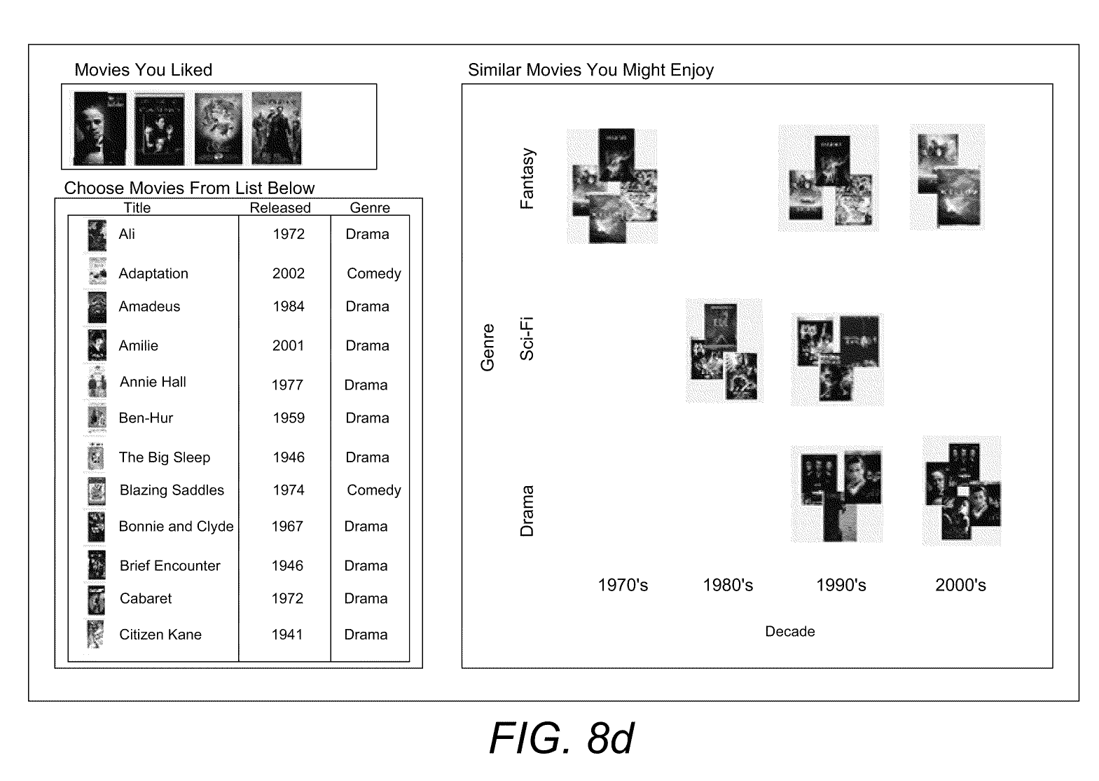

Multiple views may be presented that provide a user with various visualizations that together provide input for another visualization. FIGS. 8a-8c are views of data that are used to produce the visual of FIG. 8d. FIG. 8a represents movies from the table in FIG. 8d that a user has identified favorably, while FIG. 8b represents moves from the same table that the user has identified unfavorably. FIG. 8d is a composite view, similar to that of FIGS. 1a-1c, that shows a table from which data are chosen by a user, a visual of data that has been identified by a user, and a nested visualization that illustrate relationships among the identified data.

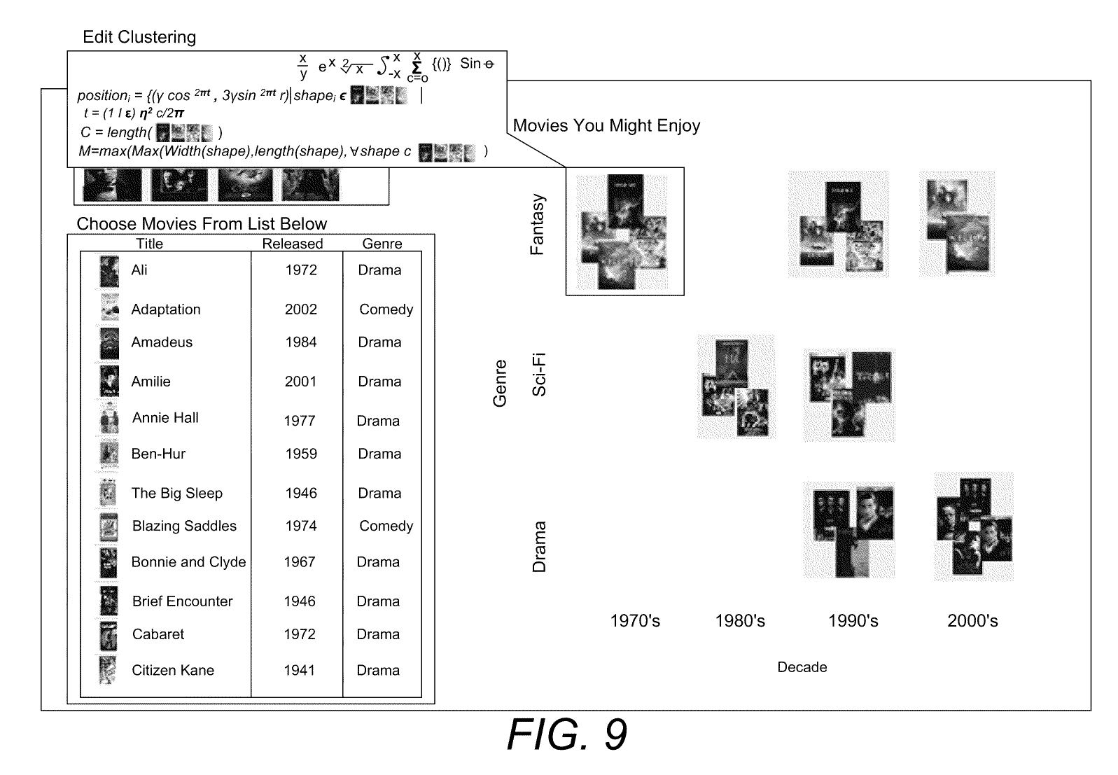

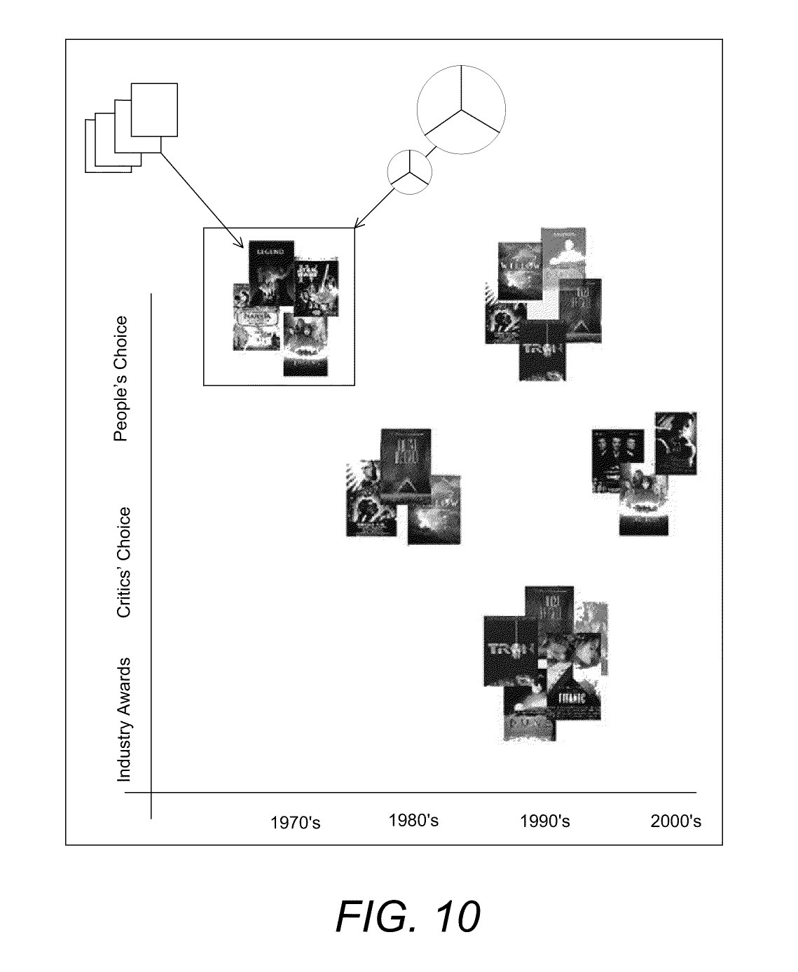

A document canvas may include features to edit visualizations. FIG. 9 shows a pop-up menu that has been expanded to allow aspects of the nested visualizations to be modified. Some examples of features that may be modified include the position of the nested cluster, the shape of the nested cluster, the length and width of the nested cluster and/or of the icons shown in the nested cluster, among other features. FIG. 10 also shows a pair of expanded pop-up menus that each represent basic visualization types that may be chosen by a user for use in the nested cluster. In the illustrated embodiment, the user is presented with choices between a circular pie chart and an arrangement of cascaded icons, although other configurations are also possible and are contemplated.

The inventors have appreciated that existing visualizations do not provide sufficiently useful information about complexly related data. As a result, the inventors have appreciated that alternative visualizations may improve a database or spreadsheet user's experience.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or conventional programming or scripting tools, and also may be compiled as executable machine language code or intermediate code that is executed on a framework or virtual machine.

In this respect, the invention may be embodied as a computer readable medium (or multiple computer readable media) (e.g., a computer memory, one or more floppy discs, compact discs, optical discs, magnetic tapes, flash memories, circuit configurations in Field Programmable Gate Arrays or other semiconductor devices, etc.) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including”, “comprising”, or “having”, “containing”, “involving”, and variations thereof herein, is meant to encompass the items listed thereafter and equivalents thereof as well as additional items.

What is claimed is:

1. A method of displaying complex relationships among data, the method comprising:
selecting a first subset of data from a database;
selecting a second subset and a third subset of data from the database;
identifying two or more relationships among the first, second, and third subsets of data; and
providing one or more visualizations that display the two or more relationships to among the first, second, and third subsets of data.

2. The method of claim 1, wherein the one or more visualizations are selected from a group consisting of: one or more tables, one or more pie charts, one or more cluster visualizations, and one or more bar graphs.

4. The method of claim 1, wherein providing the visualization includes providing two or more visualizations.

5. The method of claim 4, wherein one of the two or more visualizations is nested within another of the two or more visualizations.

6. The method of claim 5, wherein the nested visualization is configured to expand from the another visualization when selected by a user.

7. The method of claim 5, wherein there are a plurality of nested visualizations within the another of the two or more visualizations.

8. The method of claim 7, wherein the another of the two or more visualizations includes a table, and wherein the plurality of nested visualizations are configured to expand from the table when an icon representing each of the nested visualizations is selected by a user.

9. The method of claim 8, further comprising:
selecting a visualization type, including at least one of a bar graph, a table, and a cluster chart, for the nested visual, when expanded.

10. The method of claim 1, further comprising:
identifying an additional subset of data from the database that includes relationships similar to that among the first, second, and third subsets of data.

11. The method of claim 10, further comprising:
defining one or more constraints, wherein identifying the additional subset of data occurs subject to the one or more constraints.

12. A computer-readable medium having computer-readable signals stored thereon that define instructions that, as a result of being executed by a computer, control the computer to perform a method of communicating electronically, the method comprising:
recording a selection of a first subset of data from a database;
recording a selection of a second subset and a third subset of data from the database;
identifying two or more relationships among the first, second, and third subsets of data; and
providing one or more visualizations that display the two or more relationships among the first, second, and third subsets of data.

13. The computer-readable medium of claim 12, wherein providing the visualization includes providing two or more visualizations.

14. The computer-readable medium of claim 13, wherein one of the two or more visualizations is nested within another of the two or more visualizations.

15. The computer-readable medium of claim 14, wherein the nested visualization is configured to expand from the another visualization when selected by a user.

16. The computer-readable medium of claim 15, wherein there are a plurality of nested visualizations within the another of the two or more visualizations.

17. The computer-readable medium of claim 16, wherein the another of the two or more visualizations includes a table, and wherein the plurality of nested visualizations are configured to expand from the table when an icon representing each of the nested visualizations is selected by a user.

18. The computer-readable medium of claim 17, wherein the method further comprises:
selecting a visualization type, including at least one of a bar graph, a table, and a cluster chart, for the nested visual, when expanded.

19. The computer-readable medium of claim 12, wherein the method further comprises:
identifying an additional subset of data from the database that includes relationships similar to that among the first, second, and third subsets of data.

20. A method of displaying complex relationships among data, the method comprising:
selecting a first subset of data from a database;
selecting a second subset and a third subset of data from the database;
identifying two or more relationships among the first, second, and third subsets of data; and
providing a table that displays the first subset of data, including a plurality of rows and a plurality of columns, a first of the columns showing data among the first set, one each in every row, and a second of the columns showing data of the second subset, one or more in every row of that are related to data of the first column;
providing an icon in each row of the second column that, when selected, cause a nested display to expand, the nested display showing relationships between data of the second subset and data of the third subset.
